(19) United States
(12) Patent Application Publication
(10) Pub. No.: US 2009/0235549 A1
(43) Pub. Date: Sep. 24, 2009

(54) Dryer Vent Vacuum System

(76) Inventor: Del G. Cartwright, Garland, TX (US)

Correspondence Address: WILSON DANIEL SWAYZE, JR., 3804 CLEARWATER CT., PLANO, TX, 75025, US

(21) Appl. No.: 12/051,072

(22) Filed: Mar. 19, 2008

(51) Int. Cl. F26B 13/30

(52) U.S. Cl. 34/92

(57) ABSTRACT

A dryer system may include a dryer member to dry clothes or fabric, and a vacuum source member which is external to the dryer member and detachably connected to the dryer member. The dryer member may include a rotatable chamber which is in the fluid communication with the vacuum source member, and the dryer member may include a vent connector member. The vacuum source member may include an input line member which is detachably connected to the dryer member, and the vacuum source member may include a reducer member to connect to the vent connector member. The vacuum source member may include an elbow member to connect to the reducer member, and the vacuum source member may include a filter member to filter the fluid. The vacuum source member may include a output line member to output the fluid, and the vacuum source member may include an expander member to connect to the output line member. The expander member may be connected to a second elbow member.

### FIELD OF THE INVENTION

This invention relates generally to a fabric or clothes dryer, and more particularly this invention relates to a vacuum source which is detachably connected to a dryer thereby facilitating the drying of clothing and/or reducing the energy costs associated therewith.

### BACKGROUND OF THE INVENTION

Conventional household dryers, such as that described in U.S. Pat. No. 4,817,298 include a drum for receiving clothes or other fabrics to be dried which is rotatable about a horizontal axis. During operation, the drum is rotated to tumble the fabrics while heated air is passed through the drum to extract moisture from the fabrics.

When a piece of fabric is laden with moisture, the water in the fabric is believed to exist in two different states, free moisture and bound moisture. Free moisture is moisture which is not held with any significant adhesive force in the fabric. In fact, as far as evaporation is concerned, the free moisture at the surface of the fabric behaves just like a free surface of water. Thus, the free moisture freely evaporates at the saturation pressure of water at the fabric temperature. On the other hand, bound moisture is held by relatively strong molecular forces. The net result of these forces is that the bound moisture is not maintained as a free layer of water at the surface of the fabric and hence does not freely evaporate at the saturation pressure. Bound moisture comprises about 25% of the mass of the wet fabric.

When wet fabrics are exposed to a warm flow of air in a conventional dryer, three periods of drying are discerned. The first period is a “warm up” period where the fabrics and their moisture content reach a steady drying temperature. During the second period, called the “constant rate” period, the free moisture is dried at a constant rate. After all the free moisture is depleted, the third or “falling rate” period begins. In this period, the bound moisture is removed at a decreasing drying rate. This drying cycle is a relatively lengthy process which takes longer than the washing cycle of domestic washing machines. This difference can create an inconvenience to persons doing multiple loads of laundry in that the washing machine will often be sitting idle holding wet clothes from a finished cycle because the dryer is still drying a previous load.

In the past, others have taken advantage of this phenomenon in an attempt to produce a more efficient clothes dryer. For example, U.S. Pat. No. 5,724,750 issued Mar. 10, 1998 to Burress (“Burress”) discloses a clothes dryer with infrared heating and vacuum drying capabilities in which a stationary vacuum pump is capable of reducing the vacuum pressure inside the drum to a sub-atmospheric pressure. Likewise, U.S. Pat. No. 4,057,907 issued Nov. 15, 1777 to Rapino et al. (“Rapino”) details an apparatus having a vacuum pump that reduces the air pressure within a chamber, while a microwave emitter excites the water molecules. The apparatus of Burress and Rapino, however, each employ a rotating shaft and/or bearing assembly at their interface between internal regions of atmospheric and sub-atmospheric pressure.

Unfortunately, This technology can be difficult to implement. In order to obtain the tight seal necessary for maintaining the apparatus' internal vacuum, a soft bushing material, such as rubber or the like, must be utilized. Such a soft material, however, quickly wears, ultimately resulting in disintegration of the seal. On the other hand, hard materials that are impervious to wear are highly susceptible to tiny vacuum leaks, which in turn destroy the object of the invention.

U.S. Pat. No. 6,370,798 discloses a vacuum assisted dryer for accelerated drying of clothing generally including a fixed frame, a rotatable drum within the fixed frame for holding and tumbling clothing within a vacuum sealable interior space, a vacuum pump fixedly attached to the drum and a power delivery system for communicating electrical power from the fixed frame to the vacuum source on the drum. The power delivery system comprises a slip ring assembly about a spindle utilized to maintain the drum upon its axis of rotation inside the fixed frame. A plurality of heating pads are provided about the interior of the drum to facilitate drying of the clothing. A blower assembly evacuates to a conventional dryer vent moist air exhausted from the vacuum pump.

U.S. Pat. No. 5,131,169 discloses a vacuum-assisted drying apparatus and method which are provided for rapidly drying fabrics. A rotatable drum is enclosed in a nearly hermetic region. A valve is attached to an inlet of the region; a compressor is attached to an exit of the region. With the valve closed, the compressor reduces the pressure within the region to the saturated pressure of water at the temperature of the fabrics. At this point, free moisture in the fabrics evaporates. Continued operation of the compressor removes the vaporous moisture from the system. After most of the free water vapor has been depleted, the valve is opened to allow heated air to flow through the drum and to dry the remaining bound moisture.

One report on difficulties with clothes dryers states that ‘during the period of 1980 to 1998 on average, 14,500 fires per year are known to have been the result of dryers. These fires averaged 13 deaths, 239 injuries and $53.1 million in property damage per year. The statistics appear to be getting worse each year’.

### SUMMARY

A dryer system may include a dryer member to dry clothes or fabric, and a vacuum source member which is external to the dryer member and detachably connected to the dryer member.

The dryer member may include a rotatable chamber which is in the fluid communication with the vacuum source member, and the dryer member may include a vent connector member.

The vacuum source member may include an input line member which is detachably connected to the dryer member, and the vacuum source member may include a reducer member to connect to the vent connector member.

The vacuum source member may include an elbow member to connect to the reducer member, and the vacuum source member may include a filter member to filter the fluid.

The vacuum source member may include a output line member to output the fluid, and the vacuum source member may include an expander member to connect to the output line member.

The expander member may be connected to a second elbow member.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a side view of the dryer system of the present invention;

FIG. 2 illustrates a front view of the dryer system of the present invention.

### DETAILED DESCRIPTION

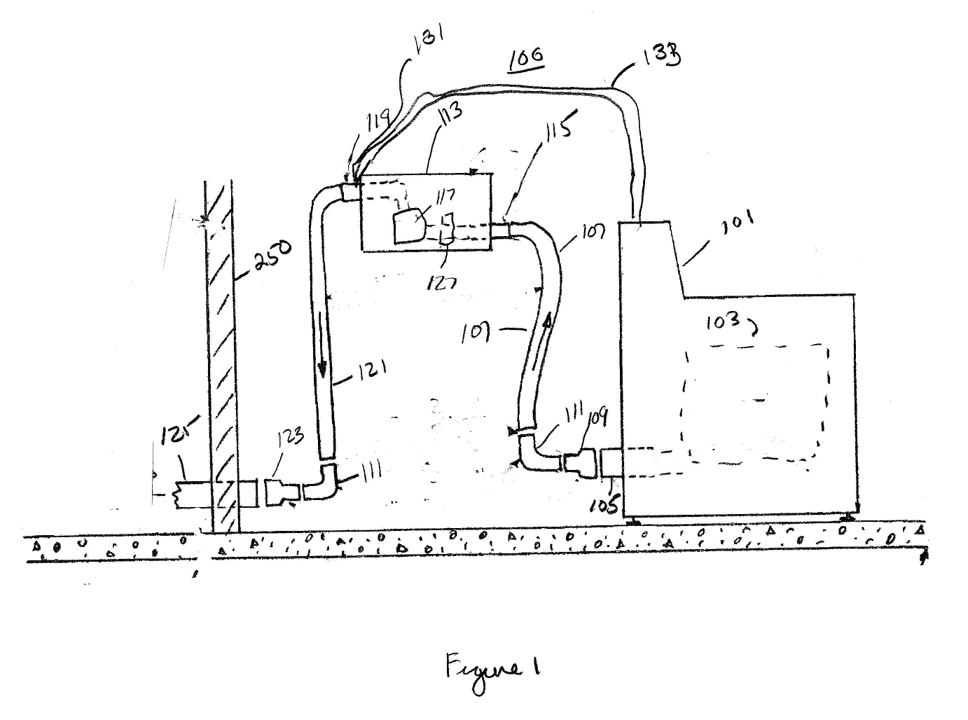

FIG. 1 illustrates a dryer system 100 with an external vacuum to the dryer member 101. The dryer member 101 which can be used to dry clothes and fabrics and other assorted materials includes a rotatable chamber 103 which is rotated by a motor (not shown) to facilitate the drying of the clothes. The rotatable chamber 103 is in fluid communication with the vent connector member 105 to vent the fluid which may be air or other suitable material to dry clothes external to the dryer member 101. The fluid may include particulate matter including lint from the air (fluid) flow exiting the dryer member 101. The vent connector member 105 may be connected to the input line member 107 by a reducer member 109 which allows differing diameters of line members to be connected together. In one embodiment, the vent connector member 105 may be a larger diameter than the input line member 107 or alternatively the vent connector member 105 may be a smaller diameter than the input line member 107. The vent connector member 105 may be substantially the same size as the input line member 107. In one embodiment, an elbow member 111 may be connected between the input line member 107 and the reducer member 109 in order to prevent kinks or bends in the input line member 107 when the vacuum source member 113 is raised above the dryer member 101 or allow the dryer member 101 to be located closer to the wall member 250. The elbow member 111 may optionally be not used. The input line member 107, the vent connector member 105, the elbow member 111, the input locking member 115, the output locking member 119, and the output line member 121 may be flexible or rigid tubing. The input line member 107 is connected to the input locking member 115 to connect the input line member 107 to the vacuum source member 113. The input locking member 115 is connected to a filter member 127 to filter lint, dust and other material which may be discharged from the rotatable chamber 103. The filter member 127 may be periodically cleaned in order to prevent the loss of velocity of the fluid from the dryer member 101. The filter member 127 is connected to the vacuum motor member 117 which generates fluid flow from the rotatable chamber 103 to the vacuum motor member 117. The vacuum source member 113 may include a failsafe member 131 to substantially eliminate the possibility of damage to the invention, the dryer and/or the home in the case of malfunction or serious overheating of the vacuum source member 113 and for the fluid from the dryer source member 113, and in some cases on the part of the user. The output locking member 119 may include a failsafe member 131 that is connected to the dryer member 101 by a wire connection member 133 which may include one or more wires. The failsafe member 131 detects the presence of a temperature which is above a predetermined temperature. When the predetermined temperature is reached, the failsafe member 131 signals the dryer member 101 through the wire connection member 133.

The fluid is exhausted from the vacuum motor member 117 and subsequently the fluid from the vacuum source member 113 is exhausted through the output locking member 119 which is connected to the output line member 121 which exhausts the fluid from the vacuum source member 103. It may be desirable to exhaust the fluid to the outside of the building which houses the dryer member 101. Optionally, the output line member 121 may be connected to a second elbow member 111 or may be directly connected to an expander member 123. As shown in FIG. 1, the second elbow member 111 is connected to the expander member 123 which is connected to the output connector member 125 which vents to the outside of the building to exhaust the fluid. The input line member 107 and the output line member 121 are detachably connected to the output locking member 119 and the input locking member 115 respectively so that the vacuum source member can be removed and replaced easily or can be eliminated to restore the dryer member 101 to the original condition without a vacuum source. Furthermore, the vacuum source member 113 can be easily implemented in almost every dryer.

In operation, the vacuum motor member 117 exhausts fluid to the output locking member 119 which exhausts the fluid to the output line member 121 which exhausts the fluid to the second elbow member 111 which exhausts the fluid to the expander member 123 which exhausts the fluid to the output connector member 125. The fluid is exhausted to the atmosphere. Furthermore, the vacuum motor member 117 pulls fluid from the filter member 127 which filters the fluid and which pulls the fluid from the input locking member 115. The input locking member 115 pulls the fluid through the input line member 107 which pulls the fluid from the first elbow member 111 which pulls the fluid from the reducer member 109. The reducer member 109 pulls the fluid from the vent connecting member 105 which pulls the fluid from the rotatable chamber 103.

The substantial increase in the air (fluid) flow that is realized by adding the vacuum source member 113 provides the following benefits. The vacuum source member 113 may be a wet/dry vacuum source which substantially eliminates concerns from moisture in the wet lint and/or air. The vacuum source member 113 consequently can be located a short or long distance from the dryer member 101 and eliminates the need for a costly, inefficient, and high maintenance secondary lint trap which is a normal requirement for a dryer vent booster product to permit it to function properly when it is located less than approximately 15 feet from a dryer member. The use of the integral high-efficiency filter member 127 yields air (fluid) that is substantially free of all lint and other particulate matter which, in turn, virtually eliminates all clogging and periodic maintenance of the output connector member 125. The vacuum source member 113 significantly increases the air (fluid) flow and achieves a significant reduction in drying time adding to the following benefits. A savings in electricity used by the dryer member 101 may result in a payback period of within six months to approximately 3 years depending on the embodiment of the invention used in each specific application. The many-fold increase in air (fluid) flow through the rotatable chamber 103 yields dry clothes that are virtually lint free. The vacuum source member 113 can be a commercially purchased wet/dry vacuum cleaner product that requires no special mounting, connecting or electrical wiring since the vacuum has a simple ‘plug-and-go’ design. The vacuum source member 113 can be easily and quickly unplugged and used as a wet/dry vacuum cleaner elsewhere in the home. The vacuum source member 113 requires no special or complicated maintenance procedures furthermore the vacuum source member 113 can be opened easily and quickly to remove any trapped lint in the filter member 127. Additionally, if a powerful wet/dry vacuum cleaner in the range of 4 to 10 HP is selected as the vacuum source member 113 to be used with a dryer, the clothes dryer can operate efficiently by using existing vent installations, and can be used with multiple bends in the output connector member 125 and with longer runs of the output connector member 125.

The dryer member is not limited to a particular input or output line member size and works well with three or 4 inch diameter output connector members 125. The present invention does not require that the existing vent runs be completely clear of lint buildup. Although, clear vent runs will achieve additional efficient operation and result in higher energy savings.

If the vacuum source member 113 is a wet dry vacuum, then, problems with moisture or particulate matter from fabric softener sheets and wet lint are eliminated. There are few practical limitations on the placement of the vacuum source member 113, but efficiencies may be achieved if vacuum source member 113 is directly connected to the dryer member 101 to ensure that virtually all the air (fluid) that flows through the vacuum source member 113 is being sucked through the dryer member 101 rather than partially through the leaks that could exist in the output connector member 125. The filter member 127 substantially traps all lint and other particulate matter that could clog the vent runs, multiple 90 degree bends etc. and therefore the system of the present invention does not require a secondary lint trap.

The increase in airflow results in the clothes drying more quickly, achieving a dramatic reduction in drying time which results in significant energy savings which are expected to allow substantially all users to recoup their initial investment in the system of the present invention within six months to approximately 3 years depending on the embodiment of the invention used in each specific application, result in a substantial increase in the useful life of the dryer and result in a significant time savings on the part of the user.

The dry clothes which are dried by the present invention are substantially lint free resulting from the greater airflow during the drying cycle.

There is no requirement for a special mounting, a connection or an electrical wire by virtue of the ‘plug and go’ design. There are no special or complicated maintenance procedures required. The vacuum source member 113 can be opened easily and lint can be quickly removed from the filter member 127 and the filter member 127 may be removed and replaced.

The vacuum source member 113 can be detached from the dryer member 101 and relocated to another location and used as a conventional ‘wet-dry vacuum’.

Whenever a dangerously high temperature is detected by the failsafe member 131, the wired connection member 133 is activated to interrupt completely the operation of the dryer member 101.

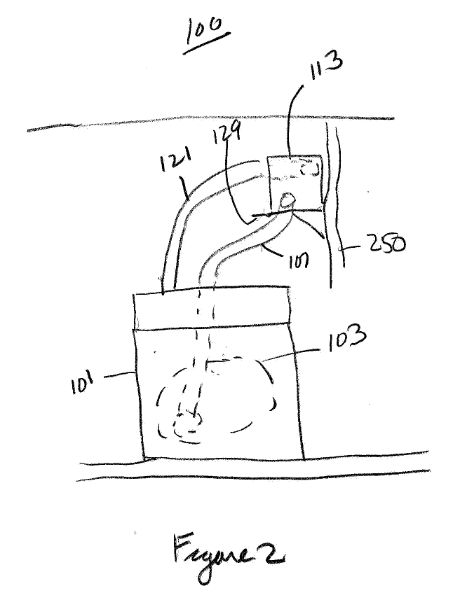

FIG. 2 illustrates a front view of the dryer system 100 with an external vacuum. FIG. 2 illustrates the dryer member 101 and the rotatable chamber 103 to dry clothes or fabrics which is detachably connected to the input line member 107 which is detachably connected to the vacuum source member 113. The vacuum source member 113 is detachably connected to the output line member 121. The vacuum source member 113 is shown as positioned on a shelf member 129 which is mounted on a wall of the house.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A dryer system, comprising:
a dryer member to dry clothes or fabric;
a vacuum source member which is external to the dryer member and detachably connected to the dryer member;
wherein the dryer member includes a rotatable chamber which is in the fluid communication with the vacuum source member.

2. A dryer system as in claim 1, wherein the dryer member includes a vent connector member.

3. A dryer system as in claim 1, wherein the vacuum source member includes an input line member which is detachably connected to the dryer member.

4. A dryer system as in claim 2, wherein the vacuum source member includes a reducer member to connect to the vent connector member.

5. A dryer system as in claim 4, wherein the vacuum source member includes an elbow member to connect to the reducer member.

6. A dryer system as in claim 1, wherein the vacuum source member includes a filter member to filter the fluid.

7. A dryer system as in claim 1, wherein the vacuum source member includes a output line member to output the fluid.

8. A dryer system as in claim 7, wherein the vacuum source member includes an expander member to connect to the output line member.

9. A dryer system as in claim 8, wherein the expander member is connected to a second elbow member.

10. A dryer system as in claim 1, wherein the vacuum source member includes a failsafe member to detect a predetermined temperature that corresponds to an unsafe condition to inactivate the dryer member.
